(19) United States
(12) Patent Application Publication
(10) Pub. No.: US 2025/0100501 A1
(43) Pub. Date: Mar. 27, 2025

(54) Seat Belt Locking Buckle

(71) Applicant: Wen-Yuan Wu, CHANGHUA (TW)

(72) Inventor: Wen-Yuan Wu, CHANGHUA (TW)

(73) Assignee: TAIWAN RACING PRODUCTS CO., LTD., Changhua (TW)

(21) Appl. No.: 18/373,828

(22) Filed: Sep. 27, 2023

(51) Int. Cl. B60R 22/18

(52) U.S. Cl. CPC B60R 22/18; B60R 2022/1806; B60R 2022/1812

(57) ABSTRACT

A seat belt locking buckle may include a fastener which is bent to form a first connecting end, and a round first connecting hole penetrating through the first connecting end is connected to a shoulder safety belt. An anti-scratch washer is coupled and connected with the inner periphery of the first connecting hole. The anti-scratch washer is outwardly folded at top and bottom ends to form an upper periphery and a lower periphery, and the anti-scratch washer is secured in the first connecting hole through the upper periphery and the lower periphery, and two round inner fillets are respectively formed at the junctions between the upper periphery and the inner periphery of the anti-scratch washer and between the lower periphery and the inner periphery of the anti-scratch washer.

### FIELD OF THE INVENTION

The present invention relates to a safety belt structure and more particularly to a buckle structure for a safety belt that enhances stability and durability of the shoulder safety belt.

### BACKGROUND OF THE INVENTION

Safety belts are devices used to restrain passengers and drivers in vehicles, so as to reduce the risk of injury during collisions or impacts and to prevent ejections, thereby minimizing the occurrence of secondary injuries. The safety belts come in various types for different needs, including lap belts for the waist, as well as more common options like three-point, four-point, and five-point safety belt. Currently, the five-point safety belts commonly used in sports cars (as shown in FIGS. 11 and 12) comprises a locking buckle (50), a buckle clip (60), a lower engaging piece (70), and two upper engaging pieces (80), and the engaging pieces (70) (80) are secured by the locking buckle (50) and the buckle clip (60). The locking buckle (50) and the buckle clip (60) are respectively connected with a first horizontal safety belt (51) and a second horizontal safety belt (61) while the lower engaging piece (70) and the upper engaging pieces (80) are respectively connected with a crotch safety belt (71) and two should safety belts (81). The buckle clip (60) has a tongue (62) formed at one end thereof, and the tongue (62) is adapted to sequentially pass through the reserved through holes of the engaging pieces (70) (80) and to insert into the locking buckle (50) so as to connect five safety belts around the user's shoulders, under the crotch, and on both sides of the abdomen, thereby providing additional body support and cushioning.

However, the conventional seat belt locking buckle has following disadvantages: (i) each of the upper engaging pieces (80) comprises a horizontal long hole (82) that is designed to allow the should safety belt (81) to be threaded and connected in a flat state, and, in actual practice, when the seatbelt fastener is tightened, the shoulder safety belt (81) is pulled down from both side of the seat back and secured by the locking buckle (50) and the buckle clip (60), which causes the shoulder safety belt (81) to form a V-shape and easily slide and accumulate towards the outer end of the horizontal long hole (82) due to the pulling force, and leads that the shoulder safety belt (81) cannot be evenly tensioned, resulting in an inclined position where the upper engaging pieces (80) collide and interfere with each other. As a result, this affects the smooth release of the seatbelt, making it difficult for the insert part to be easily pulled out, so as to significantly increase the time required to release the seatbelt. Moreover, in case of an emergency such as a collision or a serious accident, the seatbelt cannot be released promptly, which could lead to tragedies and unfortunate consequences. (ii) When the should safety belt (81) slides and displaces within the horizontal long hole (82), it simultaneously rubs back and forth against the shape edges of the horizontal long hole (82), such that the friction makes the fibers of the shoulder safety belt (81) to damage and wear, leading to the concerns of the user's safety. Therefore, there remains a need for a new and improved design for a seat belt locking buckle to overcome the problems presented above.

### SUMMARY OF THE INVENTION

The present invention provides a fastener which is bent to form a first connecting end, and a round first connecting hole penetrating through the first connecting end is connected to a shoulder safety belt. An anti-scratch washer is coupled and connected with the inner periphery of the first connecting hole. The anti-scratch washer is outwardly folded at top and bottom ends to form an upper periphery and a lower periphery, and the anti-scratch washer is secured in the first connecting hole through the upper periphery and the lower periphery, and two round inner fillets are respectively formed at the junctions between the upper periphery and the inner periphery of the anti-scratch washer and between the lower periphery and the inner periphery of the anti-scratch washer.

In one embodiment, the fastener is bent to form the first connecting end and an engaging end with an angle therebetween, and the engaging end has a vertical engaging long hole.

In another embodiment, the first connecting ends are integrally formed on one side of a locking buckle and on one side of a buckle clip respectively to directly connect with the shoulder safety belt.

Comparing with conventional seat belt locking buckle, the present invention is advantageous because: (i) the fastener is connected and coupled with the shoulder safety belt through the round shape of the first connecting hole, and when the shoulder safety belt is tightened and the buckle body is pulled, the round first connecting hole is configured to prevent the shoulder safety belt from sliding or shifting and to allow the pulling force to be concentrated, so as to maintain the fastener in a stable and centered position; (ii) the shape edge of the first connecting hole is covered by the anti-scratch washer to protect the shoulder safety belt from abrasion and damage by the sharp edge; and (iii) the inner fillet is adapted to improve the smoothness when the shoulder safety belt is pulled, so as to prevent the shoulder safety belt from being broken due to wear and tear, thereby enhancing the durability of the shoulder safety belt.

### BRIEF DESCRIPTION OF THE DRAWINGS

FIG. 1 is a three-dimensional assembly view of a seat belt locking buckle of the present invention.

FIG. 2 is a three-dimensional exploded view of the seat belt locking buckle of the present invention.

FIG. 3 is a sectional assembly view of the seat belt locking buckle of the present invention.

FIG. 4 is a sectional view illustrating an anti-scratch washer is coupled with a fastener of the seat belt locking buckle of the present invention.

FIG. 5 is a s schematic view illustrating the seat belt locking buckle of the present invention is connected a shoulder safety belt.

FIG. 6 is a sectional view illustrating the seat belt locking buckle of the present invention is connected a shoulder safety belt.

FIG. 7 is an exploded view of one embodiment of the seat belt locking buckle of the present invention.

FIG. 8 is a schematic view illustrating the seat belts are connected to the seat belt locking buckle of the present invention.

FIG. 9 is an exploded view of the second embodiment of the seat belt locking buckle of the present invention.

FIG. 10 is a schematic view illustrating the seat belts are connected to the second embodiment of the seat belt locking buckle of the present invention.

FIG. 11 is a prior art.

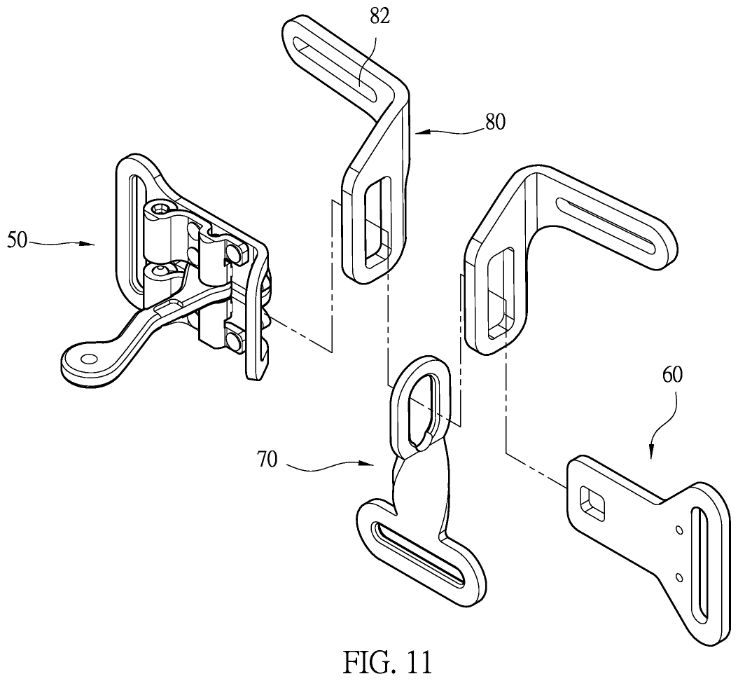

FIG. 12 is a prior art.

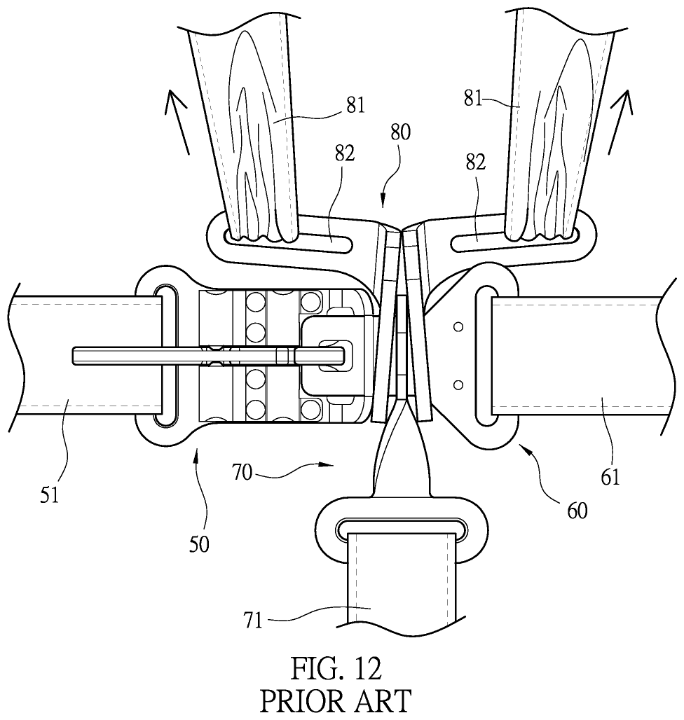

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

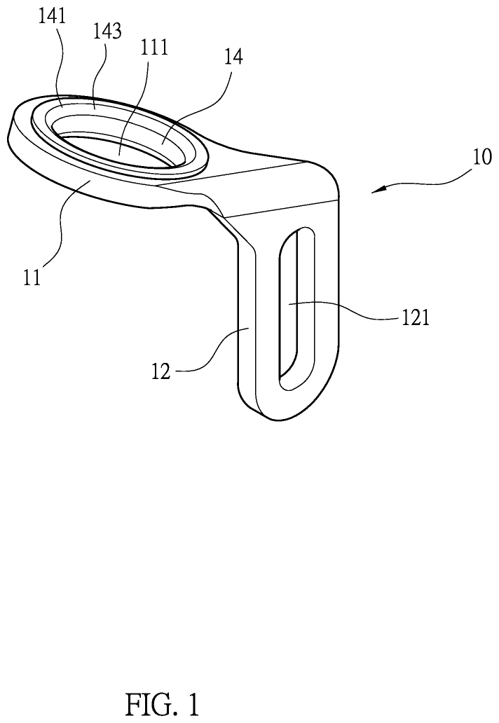

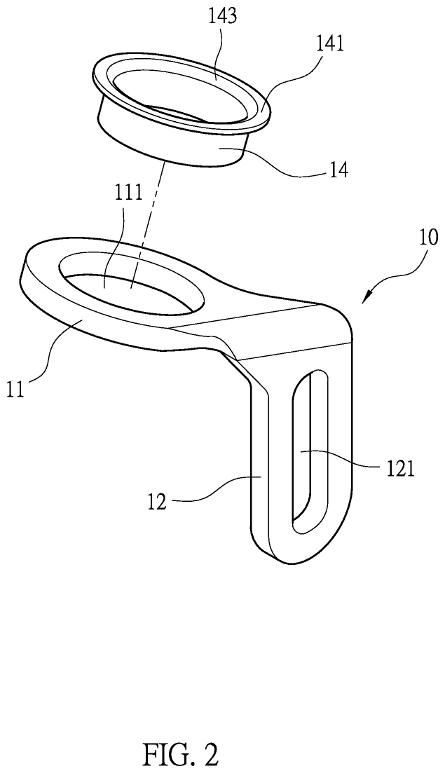

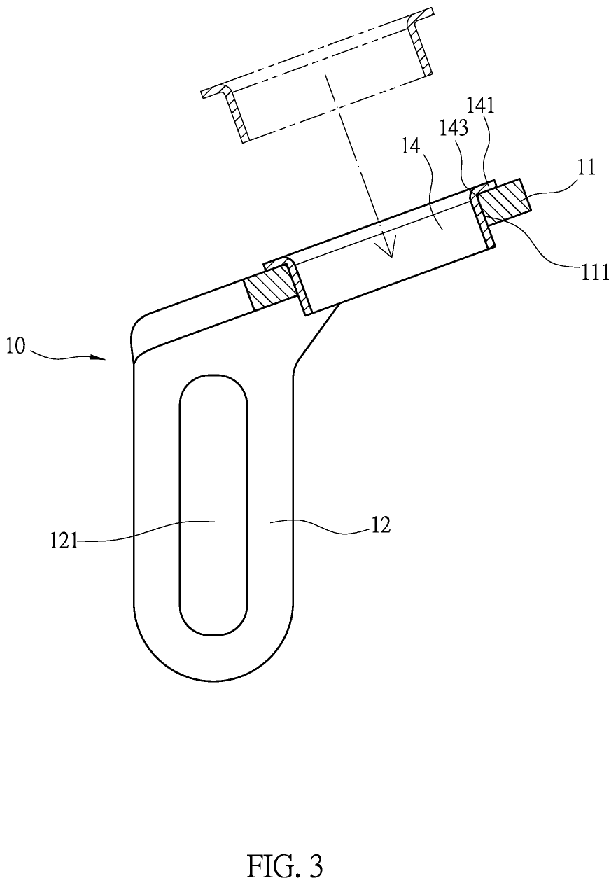

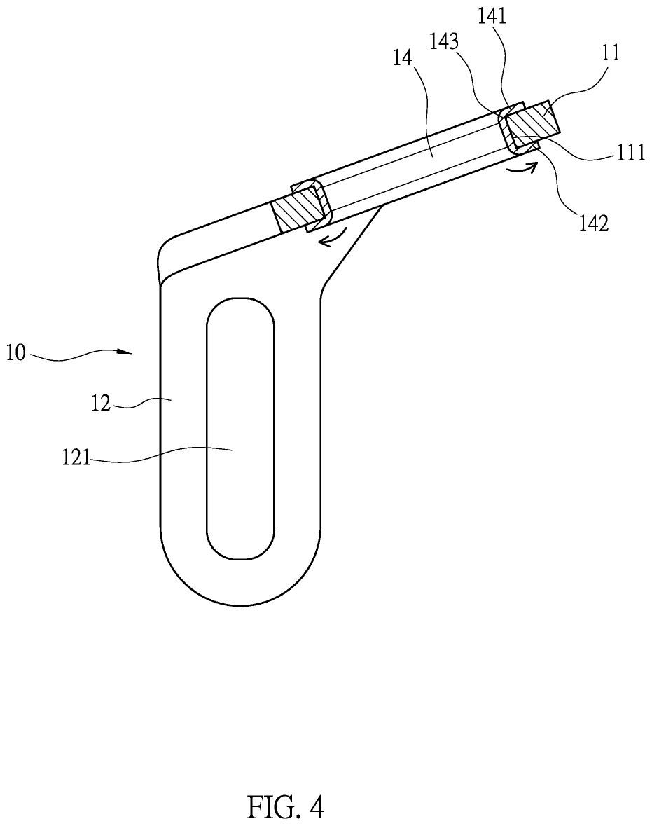

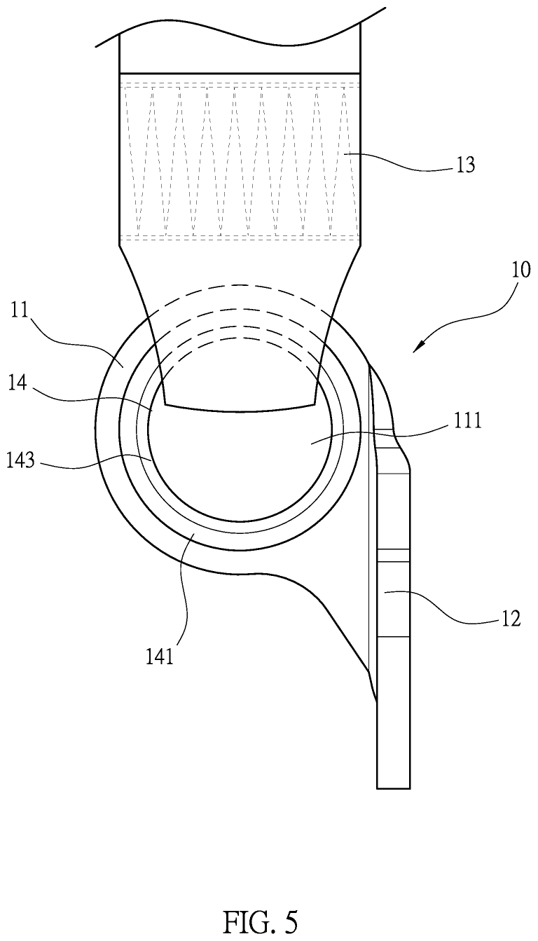

The present invention provides a seat belt locking buckle comprising a fastener (10), and, referring to FIGS. 1 to 5, the fastener (10) is bent to form a first connecting end (11) and an engaging end (12) with an angle therebetween. A round first connecting hole (111) penetrating through the first connecting end (11) is connected to a shoulder safety belt (13), and an anti-scratch washer (14) is coupled and connected with the inner periphery of the first connecting hole (111). The anti-scratch washer (14) is outwardly folded at top and bottom ends to form an upper periphery (141) and a lower periphery (142), and the anti-scratch washer (14) is secured in the first connecting hole (111) through the upper periphery (141) and the lower periphery (142), and two round inner fillets (143) are respectively formed at the junctions between the upper periphery (141) and the inner periphery of the anti-scratch washer (14) and between the lower periphery (141) and the inner periphery of the anti-scratch washer (14), and the engaging end (12) has a vertical engaging long hole (121).

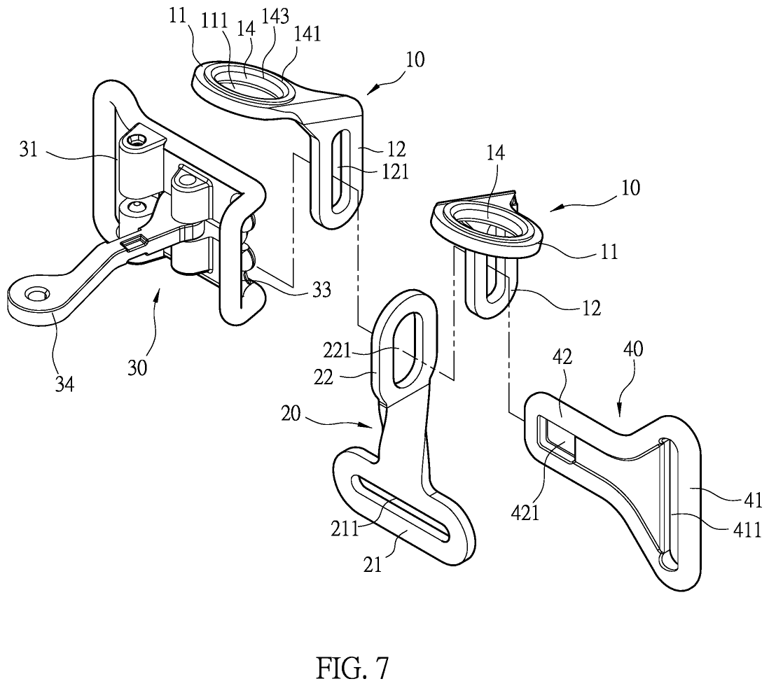

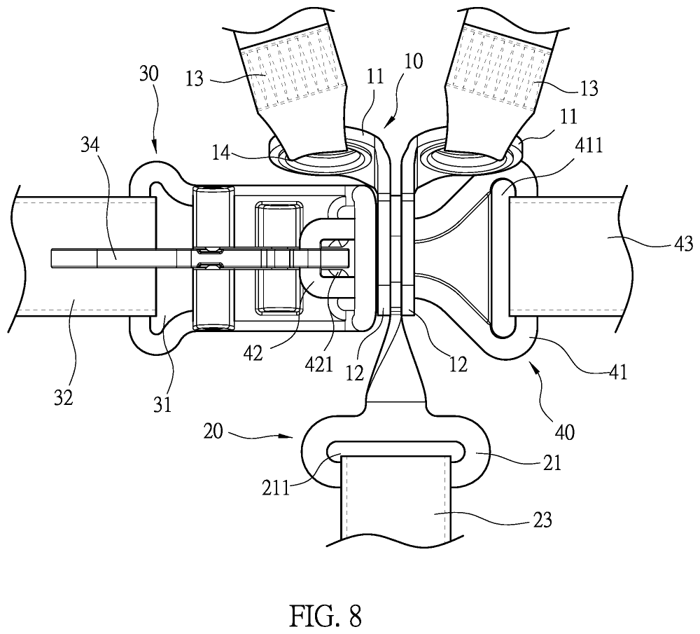

Structurally, referring to FIGS. 1, and 6-8, the two fasteners (10) are cooperated with a lower belt buckle (20), a locking buckle (30), and a buckle clip (40) to form a five-point safety belt. The two fasteners (10) formed are in mirror-symmetrical, and each of the fasteners (10) is connected with the shoulder safety belt (13) through the first connecting end (11). The lower belt buckle (20) formed in T-shape has a lower penetrated portion (21) and an engaging portion (22), and the lower penetrated portion (21) comprises a first long hole (211) to connect to and secure a crotch safety belt (23). The engaging portion (22) is rotated 90 degrees from the surface of the lower penetrated portion (21) to be perpendicular each other, and a second long hole (221) axially penetrates through the engaging portion (22). The locking buckle (30) has a third long hole (31) at one end thereof to secure a first horizontal safety belt (32), and a third long hole (31) is formed at the other end of the locking buckle (30) to be inserted by the buckle clip (40). The locking buckle (30) is pivotally connected to a pulling member (34) which is adapted to engage with and secure the buckle clip (40). The buckle clip (40) comprises a first penetrated portion (41) and a tongue portion (42) to form a horizontal T-shape, and the first penetrated portion (41) has a fifth long hole (411) to position a second horizontal safety belt (43), and a hook hole (421) is formed on the tongue portion (42) to fasten the pulling member (34) thereon.

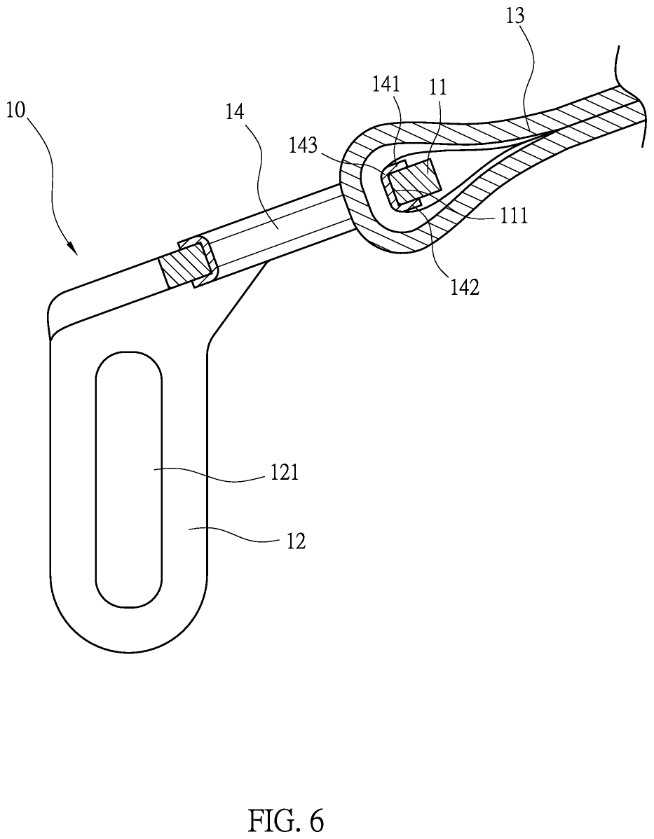

Referring to FIGS. 6 to 8, the engaging ends (12) of the fasteners (10) are pulled down to the two lateral sides of the engaging portion (22) of the lower belt buckle (20), and the two engaging long holes (121) of the two engaging ends (12) are aligned with the second long hole (221), and the tongue portion (42) of the buckle clip (40) is configured to pass through the engaging long hole (121), the second long hole (221), and the engaging long hole (121), and insert into a second connecting hole (33) of the locking buckle (30), and the pulling member (34) is configured to securely engage with the hook hole (421) of the tongue portion (42), so as to secure the lower belt buckle (20) and the two fasteners (10) onto the locking buckle (30), thereby achieving the fastened state of the five-point safety belt and ensuring the safety of the driver while driving.

More specifically, each of the fasteners (10) is connected and coupled with the shoulder safety belt (13) through the round shape of the first connecting hole (111), and when the shoulder safety belt (13) is tightened and the buckle body is pulled, the round first connecting hole (111) is configured to prevent the shoulder safety belt (13) from sliding or shifting and to allow the pulling force to be concentrated, so as to maintain the fastener (10) in a stable and centered position. In addition, the shape edge of the first connecting hole (111) is covered by the anti-scratch washer (14) to protect the shoulder safety belt (13) from abrasion and damage by the sharp edge. Also, the inner fillet (143) is adapted to improve the smoothness when the shoulder safety belt (13) is pulled, so as to prevent the shoulder safety belt (13) from being broken due to wear and tear, thereby enhancing the durability of the shoulder safety belt (13).

Furthermore, when the locking buckle (30) releases the fastening state of the buckle clip (40) through loosening the pulling member (34), one end of the shoulder safety belt (13) is adapted to remain centered within the first connecting end (111), so as to prevent the fastener (10) from being tilted or squeezed, and the tongue portion (42) of the buckle clip (40) is easily pulled out and detached to achieve the quick release of the seat belt, thereby beneficial in saving escape time in case of an accident and significantly enhancing the safety of seat belt use.

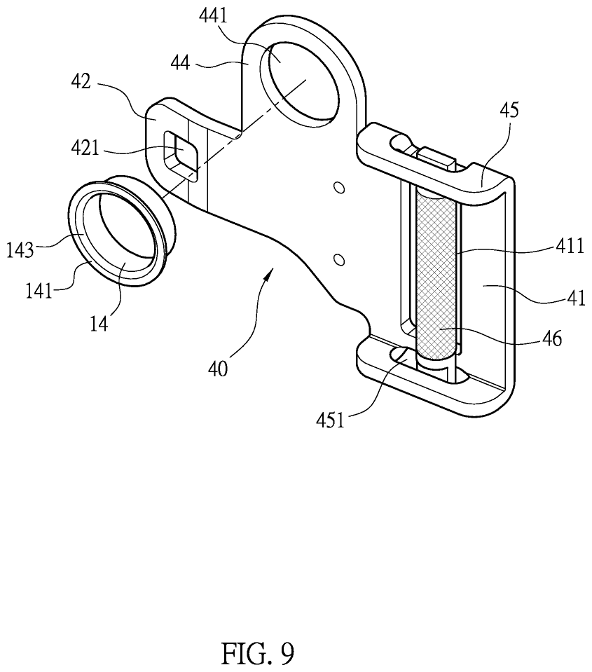

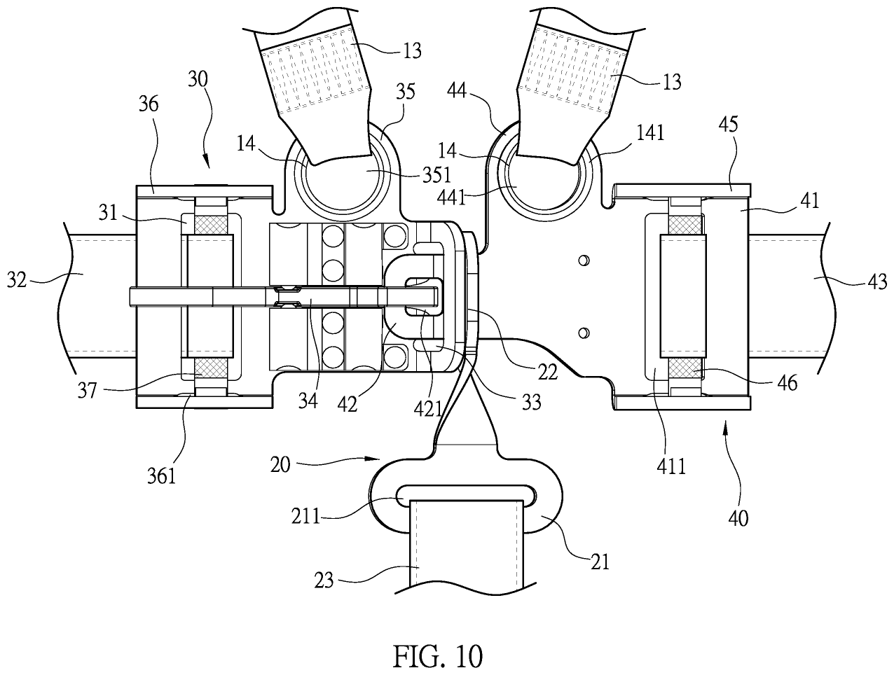

In another embodiment, referring to FIGS. 9 and 10, the first connecting ends (11) are integrally formed on one side of the locking buckle (30) and on one side of the buckle clip (40) respectively, and a second connecting end (35) is formed at one side of the locking buckle (30) and vertically positioned with respect to the second connecting hole (33). A round third connecting hole (351) penetrates through the second connecting end (35) to connect and couple with the shoulder safety belt (13). The inner periphery of the third connecting hole (351) is coupled and covered by the anti-scratch washer (14), and two lateral sides of the third long hole (31) are respectively bent to form two symmetric first side plates (36), and each of the first side plates (36) comprises a fourth long hole (361), and the two fourth long holes (361) are formed symmetrically. A first engaging rod (37) is slidably connected between the two fourth long holes (361) of the two first side plates (36), and the first engaging rod (37) is cooperated with the third long hole (31) to adjustably secure the first horizontal safety belt (32). A third connecting end (44) is formed at one side of the buckle clip (40) and vertically positioned with respect to the tongue portion (42), and a round fourth connecting hole (441) penetrates through the third connecting end (44) to connect and couple with the shoulder safety belt (13). The inner periphery of the fourth connecting hole (441) is coupled and covered by the anti-scratch washer (14), and two lateral sides of the first penetrated portion (41) are respectively bent to form two symmetric second side plates (45), and each of the second side plates (45) comprises a sixth long hole (451), and the two sixth long holes (451) are formed symmetrically. A second engaging rod (46) is slidably connected between the two sixth long holes (451) of the two second side plates (45), and the second engaging rod (46) is cooperated with the fifth long hole (411) to adjustably secure a second horizontal safety belt (43). The one-piece design of the first connecting ends (11) for assembling the shoulder safety belt (13) respectively on the locking buckle (30) and the buckle clip (40) is adapted to reduce the production cost of seat belt, and the stability and durability of the shoulder safety belt (13) is improved by the round third connecting hole (351), the round fourth connecting hole (441), and the anti-scratch washers (14).

Having described the invention by the description and illustrations above, it should be understood that these are exemplary of the invention and are not to be considered as limiting. Accordingly, the invention is not to be considered as limited by the foregoing description, but includes any equivalents.

1. A seat belt locking buckle comprising a fastener; wherein the fastener is bent to form a first connecting end, and a round first connecting hole penetrating through the first connecting end is connected to a shoulder safety belt; an anti-scratch washer is coupled and connected with an inner periphery of the first connecting hole; the anti-scratch washer is outwardly folded at top and bottom ends to form an upper periphery and a lower periphery, and the anti-scratch washer is secured in the first connecting hole through the upper periphery and the lower periphery, and two round inner fillets are respectively formed at junctions between the upper periphery and an inner periphery of the anti-scratch washer and between the lower periphery and the inner periphery of the anti-scratch washer,
wherein the fastener is connected and coupled with the shoulder safety belt through the round first connecting hole, and when the shoulder safety belt is tightened and the buckle body is pulled, the round first connecting hole is configured to prevent the shoulder safety belt from sliding or shifting and to allow the pulling force to be concentrated to maintain the fastener in a stable and centered position.

2. The seat belt locking buckle of claim 1, wherein the fastener is bent to form the first connecting end and an engaging end with an angle therebetween, and the engaging end has a vertical engaging long hole.

3. The seat belt locking buckle of claim 1, wherein one first connecting end is integrally formed on one side of a locking buckle, and another first connecting end is integrally formed on one side of a buckle clip respectively to directly connect with the shoulder safety belt.
